(19) United States
(12) Patent Application Publication
(10) Pub. No.: US 2012/0200482 A1
(43) Pub. Date: Aug. 9, 2012

(54) LIQUID CRYSTAL DISPLAY PANEL

(75) Inventors: Tetsuo Fukaya, Osaka (JP); Yuhichi Saitoh, Osaka (JP); Hiroyuki Moriwaki, Osaka (JP); Yasuhiro Nakatake, Osaka (JP); Yukio kurozumi, Osaka (JP); Masato Kakuta, Osaka (JP); Masahiko Nakamizo, Osaka (JP); Takahiro Umezawa, Osaka (JP)

(73) Assignee: SHARP KABUSHIKI KAISHA, Osaka (JP)

(21) Appl. No.: 13/500,245

(22) PCT Filed: Sep. 30, 2010
(86) PCT No.: PCT/JP2010/067157

§ 371 Date: Apr. 19, 2012

(30) Foreign Application Priority Data
Oct. 8, 2009 (JP) 2009-234639

(51) Int. Cl. G09G 3/36

(52) U.S. Cl. 345/92

(57) ABSTRACT

A liquid crystal display panel 100 has: a first substrate 11, having an active region AA having pixel electrodes and TFTs, and a gate driver region GDR provided on the outside of the active region AA; and a second substrate 21, disposed opposing the first substrate 11 with a liquid crystal layer 30 interposed therebetween, and having an opposite electrode 23. The opposite electrode 23 opposes the gate driver region GDR with the liquid crystal layer 30 interposed therebetween, and an insulating resin layer 26 is formed on the region of the opposite electrode 23 so that the insulating resin layer 26 opposes the gate driver region GDR. Thus, short-circuit failure between the driver region of the TFT substrate and the opposite electrode is eliminated.

### TECHNICAL FIELD

The present invention relates to a liquid crystal display panel, and the present invention particularly relates to a monolithic driver (integrated driver) type TFT type liquid crystal display panel.

### BACKGROUND ART

In recent years, liquid crystal display panels have been widely used as medium-scale and small-scale display panels for mobile phones, game machines, or the like, as well as in the large-scale panels used for televisions or the like. One trend in the development of liquid crystal display panels has been narrowing of the bezel. That is to say, products are being developed that have a narrowing of the frame region (i.e., the peripheral region that does not contribute to the display).

As one technique for narrowing the frame region, there is so-called monolithic driver technology that integrally incorporates the driver (drive circuit) in the TFT substrate (for example, see Patent Document 1). However, the opposite substrate has not been disposed at the region where the TFT substrate driver was formed on the conventional monolithic driver type liquid crystal display panel, and the driver has been exposed. That is to say, the driver has been formed on the TFT substrate to the exterior of the seal part used for gluing together the TFT substrate and the opposite substrate and for retaining the liquid crystal layer.

### RELATED ART DOCUMENT

### Patent Documents

Patent Document 1: Japanese Patent Application Laid-Open Publication No. 2002-6331

### SUMMARY OF THE INVENTION

### Problems to be Solved by the Invention

However, the frame region can be made narrower by arranging the driver region to the interior of the seal part rather than arranging the driver to the exterior of the seal part. When the driver region is arranged to the interior of the seal part, it is possible to simultaneously (as a unit) scribe and break the TFT substrate and CF substrate, and it is possible to decrease the alignment margin during the scribe-and-break step. Thus manufacture of a liquid crystal display panel having the driver region located to the interior of the seal part was attempted, but a short circuit failure occurred between the driver region of the TFT and the opposite electrode.

An object of the present invention is to solve the above described problem and to provide a liquid crystal display that prevents short circuit failure between the opposite electrode and the driver region of the TFT substrate.

### Means for Solving the Problems

The liquid crystal display panel of the present invention includes: a first substrate having an active region including pixel electrodes and TFTs, and a gate driver region arranged on an outside of the active region; and a second substrate having an opposite electrode disposed opposing the first substrate with a liquid crystal layer interposed therebetween, wherein the opposite electrode opposes the gate driver region with the liquid crystal layer interposed therebetween, and an insulating resin layer is formed on a region of the opposite electrode so that the insulating resin layer opposes the gate driver region.

In a certain embodiment, the first substrate has a plurality of contact parts in the aforementioned gate driver region. The plurality of contact parts includes a plurality of first contact parts connecting to clock wiring lines, and the insulating resin layer is disposed so as to prevent short circuiting between the plurality of first contact parts and the opposite electrode.

In a certain embodiment, the aforementioned insulating layer has a plurality of line-shaped parts and/or a plurality of island-shaped parts, wherein as viewed from a normal direction of the first substrate, a portion of the plurality of line-shaped parts and/or the plurality of island-shaped parts is disposed so as to overlap a portion of the plurality of first contact parts.

In a certain embodiment, the plurality of line-shaped parts and/or the plurality of island-shaped parts are arrayed with prescribed gaps therebetween, and the prescribed gaps are smaller than a width of the plurality of first contact parts.

In a certain embodiment, the aforementioned insulating resin layer is disposed so as to prevent short circuiting between the opposite electrode and all of the plurality of contact parts.

In a certain embodiment, the aforementioned first substrate further has a short ring region between the active region and the gate drive region, and the insulating resin layer is formed also on a region of the opposite substrate opposing the short ring region.

In a certain embodiment, the second substrate further includes a photo-spacer, and the insulating resin layer is formed of the same material as the photo-spacer.

In a certain embodiment, the thickness of the insulating resin layer is greater than or equal to 0.1 μm, and the insulating resin layer is thinner than the liquid crystal layer.

In a certain embodiment, the liquid crystal display panel is an MVA type liquid crystal display panel, and the second substrate further has linear protrusions provided in a region opposing the active region for controlling turn-over directions of liquid crystal molecules when a voltage is applied to the liquid crystal layer, and the protrusions are formed of the same material as the insulating resin layer.

### Effects of the Invention

The present invention provides a liquid crystal display that is capable of preventing short circuiting failures between the driver region of the TFT substrate and the opposite electrode.

### BRIEF DESCRIPTION OF THE DRAWINGS

FIG. 1(a) is a top view showing schematically the configuration of a liquid crystal display panel 100 of an embodiment of the present invention, and FIG. 1(b) is a cross-sectional drawing showing schematically the structure of a cross section at the 1B-1B′ line within FIG. 1(a).

FIG. 2(a) is a top view showing schematically the driver of the liquid crystal display panel 100. FIGS. 2(b) through (d) are top schematic views showing the insulating resin layers 26a through 26c used as the insulating resin layer 26 of the liquid crystal display panel 100.

FIG. 3 is a top view showing placement of the insulating resin layer in the liquid crystal display panel 100A of an embodiment of the present invention.

FIG. 4 is a top view showing placement of the insulating resin layer in the liquid crystal display panel 100B of an embodiment of the present invention.

FIG. 5 is a top view showing placement of the insulating resin layer in the liquid crystal display panel 100C of an embodiment of the present invention.

FIG. 6 is a cross-sectional drawing showing schematically the structure of a cross section of the liquid crystal display panel 200 of a reference example.

### DETAILED DESCRIPTION OF EMBODIMENTS

The structure of a liquid crystal display panel of an embodiment of the present invention will be explained below while referring to the drawings. The present invention is not limited by the cited embodiments.

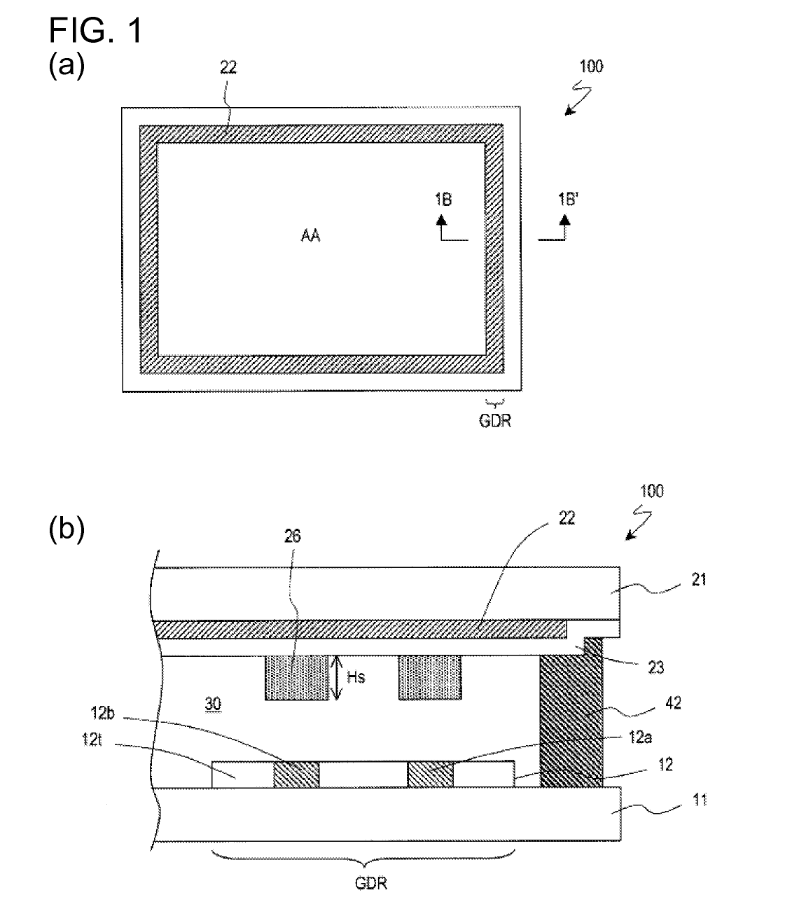

FIG. 1(a) and FIG. 1(b) show schematically the configuration of a liquid crystal display panel 100 of an embodiment of the present invention. FIG. 1(a) is a top view showing schematically the configuration of the liquid crystal display panel 100, and FIG. 1(b) is a cross-sectional drawing showing schematically the structure of a cross section at the 1B-1B′ line within FIG. 1(a).

The liquid crystal display panel 100 is a TFT type liquid crystal display panel. As shown in FIG. 1(a), the liquid crystal display panel 100 has an active region (display region) AA within a region surrounded by the black matrix 22, and has a gate driver region GDR arranged exterior to the active region AA. The gate driver region GDR is arranged at both lateral-direction sides of the active region AA. Both the active region AA and the gate driver region GDR are provided on the surface of the liquid crystal layer side of the TFT substrate. Picture element electrodes and TFTs are provided within the active region AA (neither the picture element electrodes nor the TFTs are illustrated), and a gate bus line and a source bus line are connected to the TFT. The gate driver supplies a prescribed signal to the gate bus line in a prescribed timing. Since the basic configuration of a TFT type liquid crystal display panel is well known, further details will be omitted.

As shown in FIG. 1(b), the gate driver 12 is formed in the gate driver region GDR of the TFT-side substrate 11 (e.g., glass substrate). The gate driver 12 has various types of wiring lines and contact parts 12a and 12b. The gate driver 12 has multiple driver TFTs 12t, and the driver TFTs 12t are connected to various types of wiring lines (not illustrated). The various types of wiring lines are formed by a gate metal layer (i.e., electrically conductive layer for forming the gate electrode and gate bus line of the TFT) and a source metal layer (i.e., layer for forming a source electrode and a source bus line of the TFT). Contact between a wiring line and the gate electrode or source electrode of the TFT 12t, or contact between wiring lines, is performed by contact parts 12a and 12b. The contact parts 12a and 12b are formed within contact holes provided in the insulation covering the wiring lines or the like.

An opposing-side substrate 21 (e.g., glass substrate), disposed facing the TFT-side substrate 11 with the liquid crystal layer 30 interposed therebetween, has a black matrix 22 and an opposite electrode 23 on the liquid crystal layer 30 side. The opposite electrode 23 is formed over nearly the entire face of the opposing-side substrate 21, and an insulating resin layer 26 is formed on a region of the opposite electrode 23 so as to oppose the gate driver region GDR. The TFT-substrate 11 and the opposing-side substrate 21 are glued together by a seal part 42, and these substrates retain the liquid crystal layer 30. The liquid crystal layer 30 is present also above the gate driver region GDR.

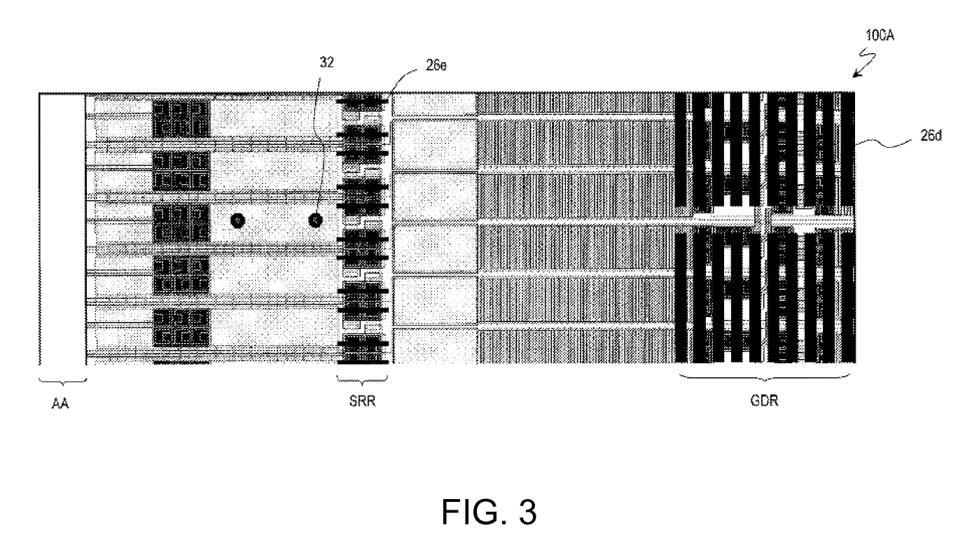

A prototype monolithic gate driver type TFT type liquid crystal display panel (26-inch type WXGA) using amorphous silicon TFTs was produced. During high temperature burn-in testing (60° C., 1,000 hours), there was a short circuit failure between the gate driver region GDR contact part 12a or 12b and the opposite electrode 23 of a liquid crystal display panel lacking an insulating resin layer 26. Although an alignment film was formed on the display region for both the TFT substrate and the opposite substrate of the prototype liquid crystal display panel, an alignment film was not formed on the frame region. Photo-spacers (spacers formed using a photosensitive resin) were provided within the display region of the opposite substrate and interior to the short ring of the frame region (e.g., refer to the photo-spacers 32 of FIG. 3) as spacers for establishing gaps between the TFT substrate and the opposite substrate. Metal-coated beads were intermixed in the seal part (see seal part 42 of FIG. 1(b)). A portion of the metal-coated beads functions as a point of contact (transfer) for supplying counter voltage from the TFT substrate side to the opposite electrode 23.

The contact part 12a of the clock wiring line was the location where the short circuit failure occurred. The contact parts are classified as contact parts 12a for contacting the clock wiring line or contact parts 12b for contacting wiring lines other than the clock wiring line. The clock signal supplied to the clock wiring line, for example, is a square wave signal having a duty ratio of 1:1 and oscillating between 40V and −6V. Voltage of the clock signal is higher than that of other signals, and the clock signal is thought to readily generate a short circuit failure with the opposite electrode 23.

The liquid crystal display panel 100 of an embodiment of the present invention has an insulating resin layer 26 on the region of the opposite electrode 23 opposing the gate driver region GDR, and it is thus possible to prevent the occurrence of short circuit failures between the opposite electrode 23 and the contact parts 12a and 12b of the gate driver region GDR. Here, height Hs of the insulating resin layer 26, as shown in FIG. 1(b), is less than thickness of the liquid crystal layer 30, for example. The insulating resin layer 26, for example, is formed using the same photosensitive resin as that of the photo-spacers. Height Hs of the insulating resin layer 26 may be equivalent to the height of the photo-spacers.

The insulation resin layer 26 may also be formed over the entire region opposing the gate driver region GDR, or as shown in FIG. 1(b), the insulating resin layer 26 may be provided only at regions opposing to the contact parts 12a and 12b. That is to say, the insulating resin layer 26 may be composed of multiple line-shaped parts and/or multiple island-shaped parts, and 1 or 2 or more of the line-shaped parts or island-shaped parts may be provided in regions corresponding to the contact parts 12a and 12b. The line-shaped part or island-shaped part of the insulating resin layer 26 may be provided at locations corresponding to all of the contact parts 12a and 12b, or these parts may be provided at a location corresponding to only the contact part 12a connected to the clock wiring line. As viewed along the direction of the normal line of the substrate, a portion of the multiple line-shaped parts and/or multiple island-shaped parts may be disposed so as to overlap a portion of the multiple contact parts 12a, or alternatively, so as to overlap each of the multiple contact parts 12a.

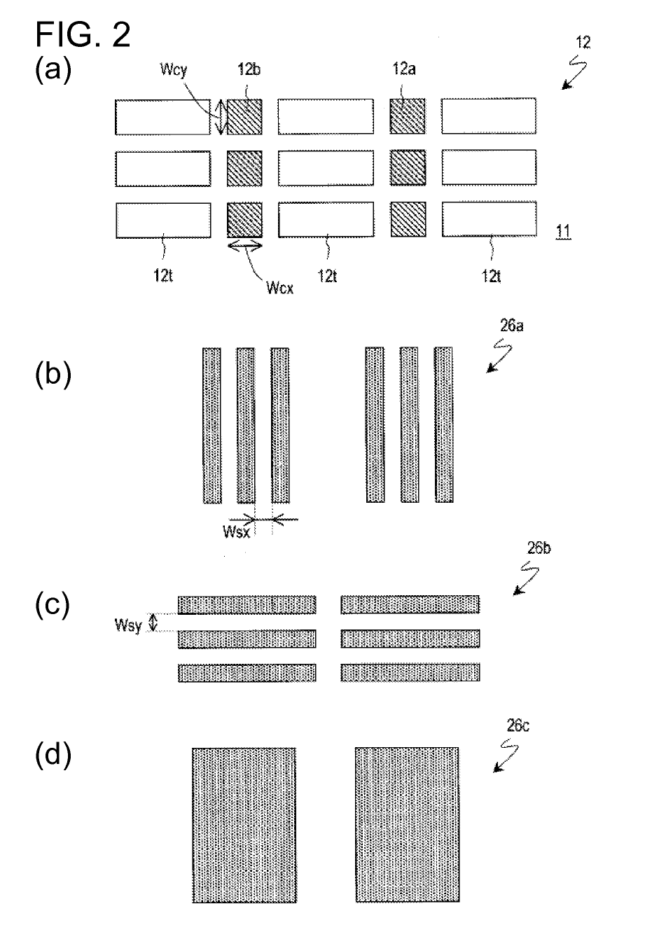

The structure of the insulating resin layer 26 will be explained next in further detail while referring to FIGS. 2(a) through 2(d). FIG. 2(a) is a top view showing schematically the driver of the liquid crystal display panel 100. FIGS. 2(b) through 2(d) are top schematic views showing the insulating resin layers 26a through 26c used as the insulating resin layer 26 of the liquid crystal display panel 100.

As shown schematically in FIG. 2(a), the gate driver 12 of the TFT-side substrate 11 has a driver TFT 12t and contact parts 12a and 12b. As indicated later using a specific example, the gate driver region GDR is provided with multiple TFTs 12t, multiple contact parts 12a, and multiple contact parts 12b (e.g., see FIG. 3). Various modifications are possible for the arrangement of the TFTs 12t and the arrangement and size of the contact parts 12a and 12b. For example, width in the row direction (x direction, horizontal direction of the display face) of the contact parts 12a and 12b is set to Wcx, and width in the column direction (y direction, vertical direction of the display face) is set to Wcy.

As shown schematically in FIG. 2(b), the insulating resin layer 26a has multiple line-shaped parts aligned in the row direction. The gap Wsx between the multiple line-shaped parts is set smaller than the width Wcx of the contact parts 12a and 12b in the row direction. The width of the line-shaped part of the insulating resin layer 26 is set smaller than the row direction width Wcx of the contact parts 12a and 12b. The column direction length of the line-shaped part of the insulating resin layer 26 is larger than the column direction width Wcy of the contact parts 12a and 12b, and each line-shaped part is formed so as to correspond to a respective contact part of the multiple contact parts 12a and 12b.

The insulating resin layer 26b shown schematically in FIG. 2(c) has multiple line-shaped parts aligned in the column direction. The gap Wsy between the multiple line-shaped parts is set smaller than the column-direction width Wcy of the contact parts 12a and 12b. The width of the line-shaped part of the insulating resin layer 26 is smaller than column-direction width Wcy of the contact parts 12a and 12b. The row-direction length of the line-shaped part of the insulating resin layer 26 is larger than the row-direction width Wcx of the contact parts 12a and 12b, and each line-shaped part is formed so as to correspond to a respective contact part of the multiple contact parts 12a and 12b.

The insulating resin layer 26c shown schematically in FIG. 2(d) has multiple island-shaped parts. Each of the island-shaped parts is disposed so as to correspond to a respective part of the multiple contact parts 12a or 12b. Each island-shaped part corresponds to 3 line-shaped parts shown in FIG. 2(b) or FIG. 2(c).

This structure of the insulating resin layer 26 used for the liquid crystal display panel 100 of the embodiment of the present invention is not limiting, and various types of variations are possible. The insulating resin layer 26 may correspond to only the contact part 12a connected to the clock wiring line. Alternatively, the insulating resin layer 26 may be disposed over the entire gate driver region GDR as line-shaped parts or island-shaped parts having insulating resin layers 26a through 26c.

An alignment film (typically a polyimide film) can be used as the insulating resin layer 26. Sufficient insulation to prevent the occurrence of short circuiting failure between the pixel electrode and the opposite electrode is not possible using the alignment film (generally has a thickness greater than or equal to 50 nm and less than or equal to 100 nm). Thus, the thickness of the insulating resin layer 26 is preferably greater than or equal to 0.1 μm. Although there is no particular upper limit for thickness of the insulating resin layer 26, this thickness may be less than the thickness of the liquid crystal layer (generally greater than or equal to 3 μm and less than or equal to 10 μm). For example, thickness of the insulating resin layer 26 may be less than or equal to 3 μm.

A specific example of configuration of the insulating resin layer 26 will be explained next while referring to FIGS. 3 through 5.

FIG. 3 is a top view showing placement of the insulating resin layer in the liquid crystal display panel 100A of an embodiment of the present invention.

The opposing-side substrate of the liquid crystal display panel 100A has an insulating resin layer 26d having multiple line-shaped parts in a region corresponding to the gate driver region GDR. The insulating resin layer 26d has line-shaped parts elongated in the column direction, and each line-shaped part is formed so as to correspond to respective 3 row parts of the gate driver. The insulating resin layer 26d is formed so as to correspond to nearly the entire region of the gate driver region GDR.

Furthermore, in a region corresponding to the short ring region SRR, the opposing-side substrate of the liquid crystal display panel 100A has an insulating resin layer 26e having multiple line-shaped parts. The insulating resin layer 26e is formed from a film that is the same as that of the insulating resin layer 26d. The insulating resin layer 26e has line shaped parts elongated in the row direction. In a well-known manner, a short ring circuit including diodes and wiring lines is formed in the short ring region SRR, and the short ring circuit has contact parts. Although a short circuit failure may be generated between the contact parts of the short ring circuit and the opposite electrode, such short circuit failure can be prevented by providing the insulating resin layer 26e.

The opposing-side substrate of the liquid crystal display panel 100A further has photo-spacers 32 to the interior of the short ring region SSR of the frame region. The photo-spacers 32, of course, are arranged within the active region AA with a prescribed gap between the photo-spacers 32. The insulating resin layers 26d and 26e are formed from the same photosensitive resin as that of the photo-spacers 32. Although the thickness (height) of the insulating layers 26d and 26e and thickness of the photo-spacers 32 differs, by use of a photomask having regions of differing light transmittance, for example, it is possible to form the insulating resin layers 26d and 26e and the photo-spacers 32 during a single exposure step.

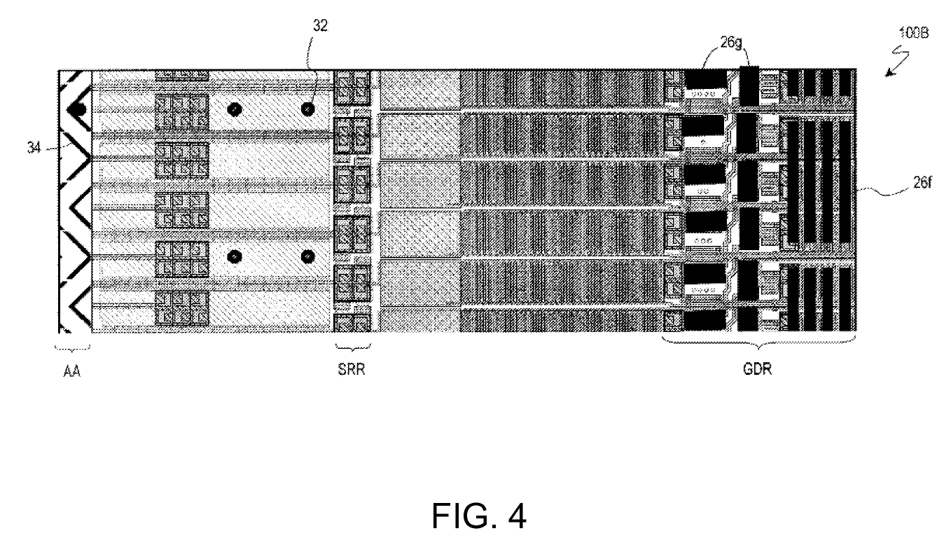

FIG. 4 is a top view showing placement of the insulating resin layer in the liquid crystal display panel 100B of an embodiment of the present invention. Except for configuration of the insulating resin layer, this is the same liquid display panel as liquid crystal display panel 100A shown in FIG. 3.

The opposing-side substrate of the liquid crystal display panel 100B has an insulating resin layer 26f having multiple line-shaped parts in a region corresponding to the gate driver region GDR, and has an insulating resin layer 26g having multiple island-shaped parts. This insulating resin layer 26f has line-shaped parts elongated in the column direction, and each line-shaped part is formed to correspond to respective 3 row parts of the gate driver. The insulating resin layers 26f and 26g are not provided corresponding to all contact parts within the gate driver region GDR, and are not provided for parts corresponding to some of the contact parts. However, insulating resin layers 26f and 26g are formed at regions corresponding to contact parts connected to the clock wiring line. Moreover, the opposing-side substrate of the liquid crystal display panel 100B has no insulating resin layer in the region corresponding to the short ring region SRR.

The opposing-side substrate of the liquid crystal display panel 100B, in the same manner as the liquid crystal display panel 100A, has photo-spacers 32 to the interior of the short ring region SRR of the frame region. The opposing-side substrate has linear protrusions 34 in a region corresponding to the active region AA. The linear protrusions 34 act by controlling the turn-over directions of the liquid crystal molecules when a voltage is applied to the liquid crystal layer. The liquid crystal panel 100B is a so-called MVA type liquid crystal display panel. The linear protrusions 34 are disposed so as to be oriented at a 45° angle relative to the polarizing axis (horizontal direction and vertical direction) of the 2 polarization plates arranged in a crossed Nicols state. The linear protrusions 34, the photo-spacers 32 and the insulating resin layers 26f and 26g can be formed by a single exposure step by use of a photomask having regions of different light transmittance values.

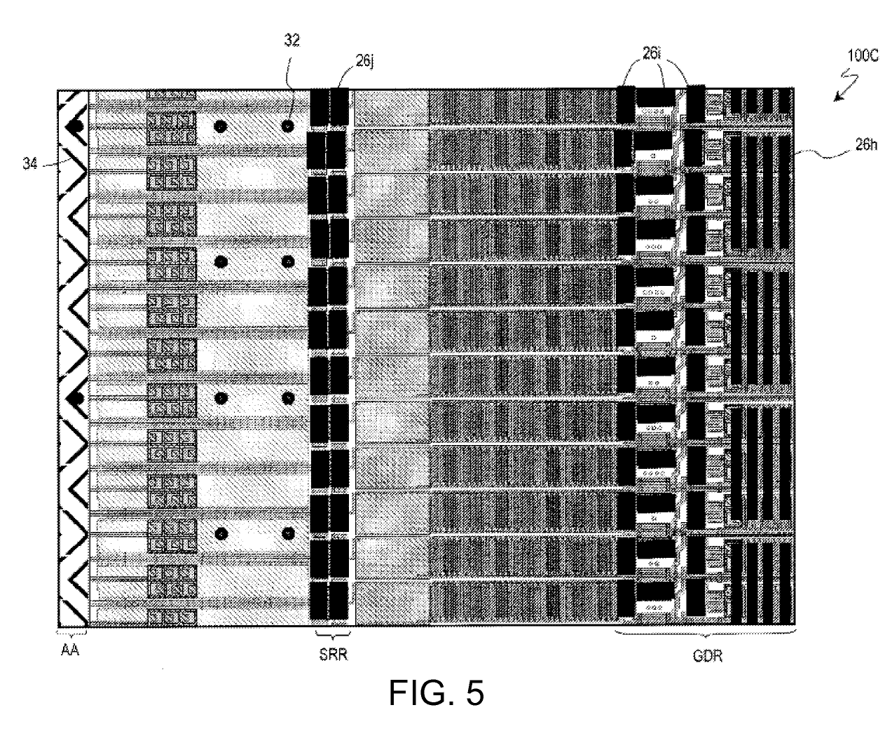

FIG. 5 is a top view showing placement of the insulating resin layer in the liquid crystal display panel 100C of an embodiment of the present invention.

The opposing-side substrate of the liquid crystal display panel 100C has an insulating layer 26h having multiple linear parts and has an insulating resin layer 26i having multiple island-shaped parts in a region corresponding to the gate driver region GDR. The insulating resin layer 26h has line-shaped parts extending in the column direction, and each line-shaped part is formed so as to correspond to respective 3 row parts of the gate driver. The insulating resin layers 26h and 26i are provided so as to correspond to all the contact parts within the gate driver region GDR. Moreover, the opposing-side substrate of the liquid crystal display panel 100C has an insulating resin layer 26j having multiple island-shaped parts in a region corresponding to the short ring region SRR.

The opposing-side substrate of the liquid crystal display panel 100C, in the same manner as the liquid display panel 100B, has photo-spacers 32 to the interior of the short ring region SRR of the frame region, and also has linear protrusions 34 in the region corresponding to the active region AA. The linear protrusions 34, the photo-spacers 32, and the insulating resin layers 26h, 26i, and 26j can be formed, for example, by a single exposure step by use of a photomask having regions of differing light transmittances.

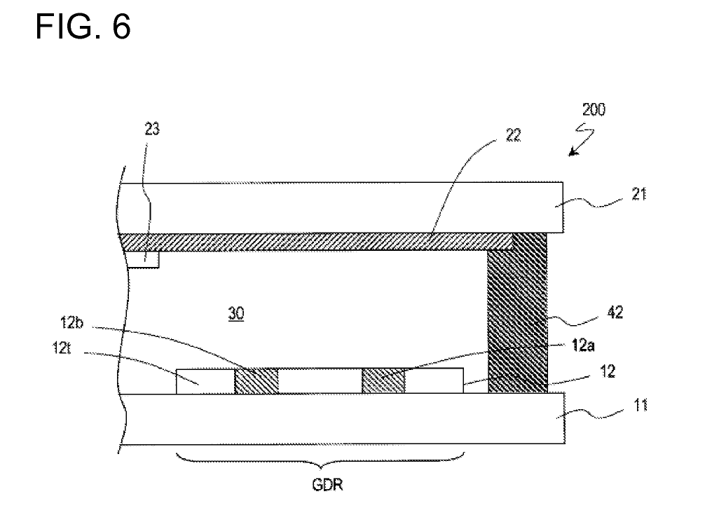

By providing the insulating resin layer 26 in the aforementioned examples, short circuit failure was prevented between the opposite electrode 23 and the driver region GDR of the TFT-side substrate 11 (for example, see FIG. 1(b)). However, as in the liquid crystal display panel 200 shown in FIG. 6, a configuration may be adopted that does not provide the opposite electrode 23 (i.e., cuts away the opposite electrode 23) at the region opposing the driver region GDR. However, the adoption of a configuration that provides the insulating resin layer in the above described manner is advantageous from the standpoint of manufacturing costs or the like, since a photoresist layer-forming step and a step of patterning the opposite electrode using the photoresist layer as a mask would otherwise be added, in comparison to a liquid crystal display panel like an MVA type liquid crystal display panel that does not require patterning of the opposite electrode.

Embodiments of the present invention have been explained in the aforementioned examples using an MVA type liquid crystal display panel as an example. However, the present invention is not limited to this type of display panel, and the present invention can be used widely for known TFT type liquid crystal display panels, such as TN type and IPS type liquid crystal display panels.

### INDUSTRIAL APPLICABILITY

The present invention is suitable for wide use for monolithic driver type liquid crystal display panels.

### DESCRIPTION OF REFERENCE CHARACTERS

11 TFT-side substrate
12 gate driver
12a, 12b contact parts
12t TFT
21 opposing-side substrate
22 black matrix
23 opposite electrode
26, 26a, 26b, 26c, 26d, 26e, 26f, 26g, 26h, 26i insulating resin layers
30 liquid crystal layer
42 seal part
GDR gate driver region
100, 100A, 100B, 100C liquid crystal display panel

1. A liquid crystal display panel comprising:
a first substrate having an active region including pixel electrodes and TFTs, and a gate driver region arranged on an outside of said active region; and
a second substrate having an opposite electrode disposed opposing the first substrate with a liquid crystal layer interposed therebetween,
wherein said opposite electrode opposes said gate driver region with the liquid crystal layer interposed therebetween, and an insulating resin layer is formed on a region of said opposite electrode so that said insulating resin layer opposes said gate driver region.

2. The liquid crystal display panel according to claim 1,
wherein said first substrate has a plurality of contact parts in said gate driver region, and said plurality of contact parts includes a plurality of first contract parts connecting to clock wiring lines, and
wherein said insulating resin layer is disposed so as to prevent short circuiting between said plurality of first contact parts and said opposite electrode.

3. The liquid crystal display panel according to claim 2,
wherein said insulating resin layer has a plurality of line-shaped parts and/or a plurality of island-shaped parts, and
wherein as viewed from a normal direction of said first substrate, a portion of said plurality of line-shaped parts and/or said plurality of island-shaped parts is disposed so as to overlap a portion of said plurality of first contact parts.

4. The liquid crystal display panel according to claim 3, wherein said plurality of line-shaped parts and/or said plurality of island-shaped parts are arrayed with prescribed gaps therebetween, and said prescribed gaps are smaller than a width of said plurality of first contact parts.

5. The liquid crystal display panel according to claim 2, wherein said insulating resin layer is disposed so as to prevent short circuiting between said opposite electrode and all of said plurality of contact parts.

6. The liquid crystal display panel according to claim 1,
wherein said first substrate further has a short ring region between said active region and said gate driver region, and
wherein said insulating resin layer is formed also on a region of said opposite substrate opposing said short ring region.

7. The liquid crystal display panel according to claim 1, wherein said second substrate further comprises photo-spacer, and said insulating resin layer is formed of the same material as said photo-spacers.

8. The liquid crystal display panel according to claim 1, wherein the thickness of said insulating resin layer is greater than or equal to 0.1 μm, and said insulating resin layer is thinner than said liquid crystal layer.

9. The liquid crystal display panel according to claim 1,
wherein said liquid crystal display panel is an MVA type liquid crystal display panel, and
wherein said second substrate further has linear protrusions for controlling turn-over directions of liquid crystal molecules when a voltage is applied to said liquid crystal layer, and said protrusions are formed of the same material as said insulating resin layer.
